(19) United States
(12) Patent Application Publication
(10) Pub. No.: US 2005/0039335 A1
(43) Pub. Date: Feb. 24, 2005

(54) Candle wick maintenance instrument

(76) Inventors: Bruce Willian Forsberg, Hazel Green, AL (US); Linda Kay Forsberg, Hazel Green, AL (US)

Correspondence Address: BRUCE FORSBERG, 134 BUTCH CASH ROAD, HAZEL GREEN, AL, 35750, US

(21) Appl. No.: 10/642,817

(22) Filed: Aug. 19, 2003

(51) Int. Cl. B26B 1/00

(52) U.S. Cl. 30/134; 30/187

(57) ABSTRACT

An apparatus and method suitable to simultaneously trim the burnt wick of a candle to the proper length and remove and hold the wick clipping from a candle that has limited horizontal access.

### BACKGROUND

This invention relates to an instrument that trims and removes the excess partially burned wick of a candle, which is not easily trimmed horizontally by an ordinary pair of scissors.

As a candle burns, the wax and wick of the candle are consumed. When the candle is extinguished, the wax cools and shrinks leaving a longer portion of the candlewick exposed. If the candle wick is re-ignited with no maintenance function performed on the candle wick, there will be a much larger flame, the flame will emanate black smoke, carbon will build up on the inside surface of deep candles or containers, and carbon mushroom-like nodules (here-in after called NUB or NUBS) can form that drop into the waxy pool of the candle. Candle manufacturers typically recommend that the wick be trimmed to approximately one-quarter inch above the cooled wax level. The carbon NUBS must be removed so they do not melt into the hot wax pool so that no additional flame supportive materials are present other than the single candlewick.

Candles have been utilized to provide light for many years so that dealing with the wick trimming issue is not new. Typically, scissors were used to cut the wicks to the proper length and the wick clipping was either balanced on a blade of the scissors or dropped in the hand for further disposal. Many people break off the carbon portion of the wick with their fingers, hold the Numb, and then discard the NUB accordingly. However, this leaves the fingers blackened and the wick not trimmed to the recommended length. Thus it does not burn as intended and produces excessive black smoke. Since candles were typically made rather long and thin, it was quite easy for a pair of scissors to trim the wick. There were even scissors made (now considered antiques) that attached a small box to one of the scissors blades that was used to catch the trimmed wicks when these long narrow candles were trimmed. There is available a candle snuffer that is shaped like a pair of scissors that snuffs the candle and captures the smoke and the unpleasant odor after the candle is extinguished. This snuffer also states that it is a wick trimmer because it appears to break off parts of the wick presumably the part that smokes. This devise is used while the candle is burning and trims only the carbonized part of the wick, not into the substantive portion of the wick to get to the one-quarter inch desired length. This instrument is also susceptible to hot wax build-up on the snuffer. In addition, the unit is to hold the smoking carbonized portion of the wick until it stops smoking and then the operator is to empty the smoke outside the home, which is not indusive to repeated use.

Today, candles have turned more toward a decorative or romantic utilization rather than to function primarily as a means of illumination. As such, candles come in many different types of sizes, shapes, jars, pots, or containers. Diameters have increased and some have multiple wicks. Whereas the candles wax was consumed as the wick was burned, the wick was left exposed for trimming. Many candies today, as the candlewick burns, leave an outer ring around the wick, either in wax or container form, which inhibits the use of scissors to horizontally trim the wick. Scissors can still be used to trim these deeper wicked candles but at a much more vertical angle which allows for the dipped wick to fall on top of the hardened candle wax surface. So as not to form an accumulation of wick clippings and cause a potential fire hazard, the dipping must be removed with ones fingers, a tweezers like mechanism, or with the inversion of the candle. Some wick trimmers have been designed to cut the wick and balance it for extraction from the wax well, however this is not a positive method of NUB removal. The finger method of wick trimming is an option as long as access is available to the wick; however the wick is still not trimmed to the typical manufacturers recommended trim length.

Previously, it was relatively easy to tend wicks with a pair of scissors on unobstructed wick exposed candles. Recent other devices have addressed vertical trimming of wicks capable of cutting only one wick without emptying the devise. A new type of wick trimming method is required to cut multiple candle wicks to the proper length and remove the wick clipping to a secure location so the clipping does not fall down into the candle or out onto the carpet, floor, or furniture thus creating a black mess on whatever it touches. In light of the other available wick trimming instruments, this is the only device capable of trimming multiple wicks without user intervention for individual NUB removal from the instrument.

### SUMMARY

The present invention has been made in view of the above-explained inadequacies of the known method of wick maintenance apparatus and methods and has the objective to provide a simple easy to use instrument which will encourage proper wick maintenance thereby reducing the possibility of fire due to wick clipping in the hot pool of wax and reduce the amount of carbon and products of incomplete combustion that are generated in the home by wicks being burnt that are excessive in length.

Use of this instrument will allow for the proper maintenance of candlewicks where horizontal access to the candlewick is obstructed by existing candle wax, jar, pot, or other obtrusive form. The idea is to use a vertical oriented instrument with a small horizontally oriented cutting surface and a holding compartment within the instrument to simultaneously cut the wick to the desired length and remove and hold the dipped wick so that it does not fall down into the candle or out on the floor or furniture. The cutting device will be capable of cutting the carbonized portion of the wick as well as the substantial portion of the wick that has not been carbonized. The NUB compartment will be large enough to hold multiple wick cuttings. The number of cuttings will be dependent upon the size of the wick and the amount of NUBS secured. Use of this instrument will reduce the possibility of wick NUBS from forming and falling into the hot wax pool because the wick starts at the recommended length thus large NUBS are not as easily formed. Proper orientation of the instrument upon use for clipping will also determine the number of wicks capable of being held.

In addition, with today's mechanical ease of use, and today's make life simple attitude, this instrument will be utilized much more frequently for the novelty appeal. It is also simple to retrieve multiple wick clippings and discard the collected NUBS at a later date thus saving time in the process.

### BRIEF DESCRIPTION OF DRAWINGS

FIG. 1 is an illustration view of the instrument

FIG. 2 is an isometric view of the instrument

FIG. 3 is an alternative illustration of an instrument

FIG. 4 is a cross sectional view of the cutting head

FIG. 5 is an alternate illustration view of the instrument

FIG. 6 is a cross sectional view of the cutting head

### DETAILED DESCRIPTION

Preferred Embodiment

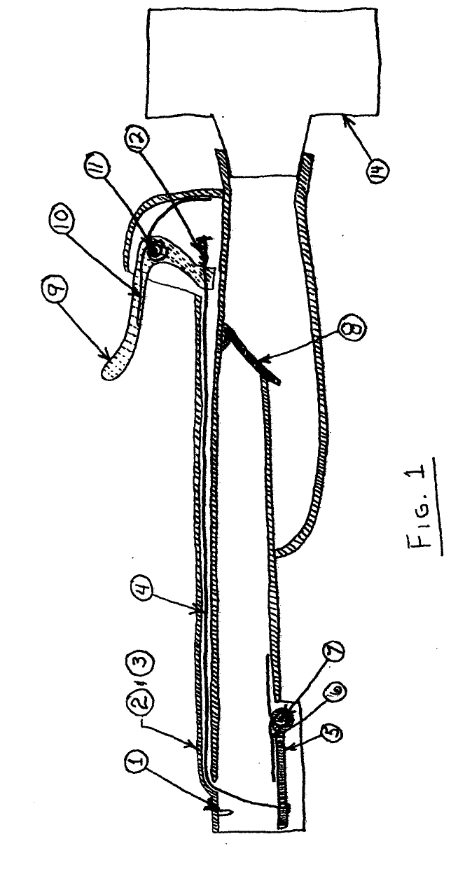

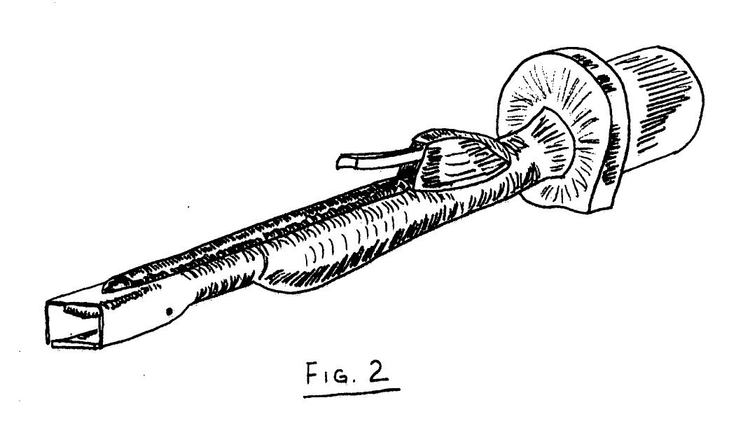

The preferred embodiment is as per FIG. 1 in which piece number 2 and 3 form the two halves of the main instrument body. Piece number 5 is a cutting flapper that pulls the NUB against the cutting blade piece number 1. Piece 5 is actuated by a pull cable piece number 4 which is functioned by the operator via the actuation lever piece number 9. A cutting flapper spring piece number 6 and pin piece number 7 are used for pivoting and returning the flapper to the original start position. Piece number 11 is the pivot pin for the actuation lever. The actuation lever is returned to the original starting position by a spring, piece number 10. Piece 12 is a pressure limiting spring on the actuation lever that enables the operator to cut the NUB without applying excessive force. Piece number 12 may be eliminated with implementation of certain quality control techniques. Piece number 14 is a battery powered suction device capable of recharge or use with disposable batteries. This suction unit can be obtained from an independent commercial source or designed specifically for this application.

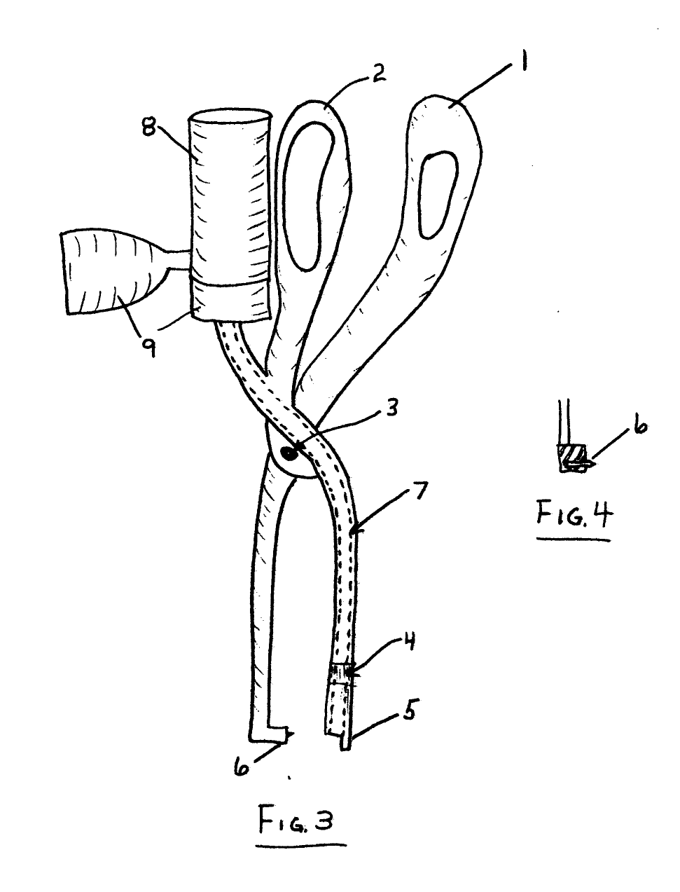

An alternate to the preferred embodiment may be the use of a scissors like instrument as in FIG. 3. Piece number 1 and piece number 2 are handles that are attached by a pivot pin, piece number 3. Piece number 4 is a flared section of the vacuum tube piece number 7 which has the solid cutting surface piece number 5 for one of the cut planes. Piece 5 also acts to limit the depth at which the wick can be cut so that it is not cut too short. It can be made to be adjustable with a slide plate (not shown) in case the user desires to cut at a taller wick height. Piece number 6 is the second cutting surface which can be either made out of preformed plastic or hardened steel, see FIG. 4. The hardened steel is desired if virgin wick is to be cut otherwise the plastic knife edge will be sufficient to cut the carbonized wick material. Piece 7 leads up to a vacuum source piece number 8, where the cut off dipping is collected and stored. The filter bag, piece number 9, is used to filter all fine particulate from entering the air that is removed from the cooled candle by the vacuum.

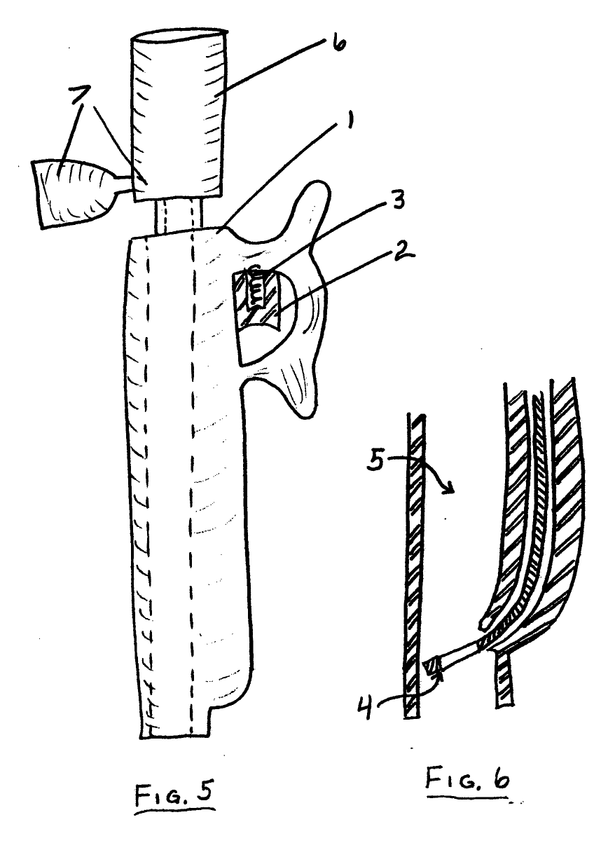

An alternative method is used in FIG. 5 in which the vacuum tube, piece 1, is the body of the unit. Piece 2 is the actuating trigger, which pulls a loop knife type blade, piece 4 of FIG. 6, to cut off the wick. Piece number 3 is a spring that returns the cut-off trigger to the beginning position. Piece number 5 is the vacuum tube that leads up to a vacuum source piece number 6, where the cut off dipping is collected and stored. The filter bag, piece number 7, is used to filter all fine particulate from entering the air.

Alternatives to this preferred embodiment also include:
Dual trim blades to cut the wick, one blade approaching the other from the opposite direction.
Multiple wick dip holding pockets may be utilized to increase the holding capacity of the instrument either by use of the handle, vacuum tube, or bag.
A tweezers like action devise may be used with a pivot at one end and the cutting blade on the other end.
A clipped wick pocket may not be required to be utilized when the instrument is to be used to dip single wicks with manual discard of dipping upon each function of the devise.
An adjustable trim length gage can be utilized to vary from typical manufacturers trim length specification if desired.

This patent is to use a vertically oriented cutter with a horizontal trim device in an obstructed area which is capable of cutting the wick to the proper length and retrieving the wick dipping from the candle and holding a multiple number of these clippings for future discard.

1. An apparatus for trimming candle wicks comprising:
A means of vertically trimming a candle wick
A means of candle wick dipping removal from the immediate surroundings of the candle or container
A means to hold multiple candle wick clippings in the instrument

2. The apparatus of claim 1, wherein the instrument has a cutting devise and a backing pad upon which to produce a cutting or trim plane.

3. The apparatus of claim 1, wherein the instrument has a dual opposing cutting devise surface

4. The apparatus of claim 1, wherein the instrument has a like action or reverse scissors like action.

5. The apparatus of claim 1, wherein the instrument has a loop type cutting tool.

6. The apparatus of claim 1, wherein the instrument has a tweezers like action.

7. The apparatus of claim 1, wherein the instrument has a pocket to hold the wick clipping or multiple wick clippings.

8. The apparatus of claim 1, herein a means of suction is used to vacuum the wick dipping to a holding pocket so that more wicks can be trimmed prior to discard.

9. The apparatus of claim 1, wherein the instrument has a manual tilt ability to be able to move the NUB to the holding pocket by gravity for multiple NUB collection.

10. The apparatus of claim 1, wherein the unit is fabricated of metal, glass, ceramic, plastic, of other and combinations of these or like items.

11. The apparatus of claim 1, wherein the instrument has a length to trim the wick per candle manufacturers established distance above the coded wax surface of the candle.

12. The apparatus of claim 1, wherein the instrument has an adjustable length to trim the wick to the operator preferred distance above the cooled wax surface of the candle.

13. A method for dipping candle wicks comprising the steps of
Inserting an instrument into a candle or candle container either vertically or predominately vertically;
Trim and hold the wick dipping of a candle;
Removal of the instrument from the candle or candle container while holding the wick clipping;
Discarding of the wick dipping or multiple use of the instrument prior to discarding the wick dipping.

14. A method of claim 13, wherein the instrument is sufficiently narrow to allow vertical or predominately vertical entry into the candle or candle container.

15. A method of claim 13, wherein one or two trimming devices cut the virgin or substantial portion of the wick material.

16. A method of claim 13, wherein the instrument encapsulates the wick clipping for removal.

17. A method of claim 13, wherein the instrument holds multiple wick clippings prior to disposal.

18. A method of claim 13, wherein the instrument cuts the candlewick to the manufactures and/or the operations recommended or desired length.

19. A method of claim 13, wherein the instrument uses a scissors or reverse scissors or trigger action to accomplish this method.

20. A method of claim 13 wherein the instrument may be used to remove loose NUBS laying on the cooled wax floor thus not requiring candle inversion for removal.
